(19) United States
(12) Patent Application Publication
(10) Pub. No.: US 2005/0286212 A1
(43) Pub. Date: Dec. 29, 2005

(54) Appliance cover method and system

(76) Inventors: Cyril Brignone, Palo Alto, CA (US); Salil Pradhan, San Jose, CA (US); Mark Smith, San Mateo, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/881,212

(22) Filed: Jun. 29, 2004

(51) Int. Cl. G06F 1/16

(52) U.S. Cl. 361/679

(57) ABSTRACT

A cover embedded with functions is provided to add functionality to an appliance. The cover includes a connection associated with the cover to connect to a peripheral port of the appliance, electronics and logic embedded into the cover that utilizes the connection to operate and provide one or more functions to complement operation of the appliance and a mechanism that removably couples the cover to the appliance.

### BACKGROUND OF THE INVENTION

The present invention relates to portable electronic appliances. These electronic appliances are designed to be smaller and more portable than general purpose desktop computers or laptops. The interface to these appliances is built around one or several buttons combined with a combination display and touch-sensitive screen. Applications running on the appliance utilize the buttons and the touch-sensitive screen differently depending on their function or purpose.

An increased reliance on using these appliances in lieu of general purpose computers has begun to impact their portability and ease of use. Instead of carrying a laptop, many users may need to carry several different appliances. Each appliance is generally directed towards performing one or possibly two general functions. For example, a user may carry a cell phone and personal digital assistant (PDA) to work instead of a laptop. Sometimes users purchase hybrid appliances that combine the functions of a personal digital assistant (PDA) appliance (i.e., a basic calendar, address book, and calculator) with a phone capable of voice communications. These hybrid devices are often expensive and much larger than the more basic PDA device.

Instead of using the larger hybrid appliance, some users purchase an extension component that slides over the back of the PDA providing additional slots for memory or other functions not built into the PDA. Manufacturers of these PDAs also often create these extension components as accessories or allow third parties to manufacture the extension components for the PDA. For example, a case that slides around the back of the PDA can have slots and electronics for integrating flash memory with the PDA for added memory and storage capabilities. Additionally, there are also cases that slide around the back of the PDA providing a slot for PCMCIA or other existing pluggable card function technology. Unfortunately, these cases are bulky and also make the PDA device less portable and desirable.

Current accessories for the PDA also do not tend to work together. The cases typically supplied with a new PDA will not fit a PDA having an extended battery or the extension described previously slid over the back of the PDA. Because of these incompatibilities, PDAs equipped with these accessories leave the PDA device subject to damage and imminent repair. For example, the combination display and touch-sensitive screen exposed on a PDA is easily damaged if it is dropped or hit with a hard object.

There is a need to address these and other concerns associated with increasing the portability, functionality and reliability of portable electronic appliances.

### BRIEF DESCRIPTION OF THE DRAWINGS

FIG. 1 is a schematic diagram of a system having an appliance and a smart cover designed in accordance with implementations of the present invention;

FIG. 2A through 2E are schematic diagrams illustrating various smart cover designs implemented in accordance with the present invention;

FIG. 3A through 3D are several different perspectives and views of a smart cover designed in accordance with implementations of the present invention;

FIG. 4 is a flowchart diagram for manufacturing a smart cover designed in accordance with implementations of the present invention; and

FIG. 5 is a schematic diagram of a smart cover and components used in accordance with one implementation of the present invention.

Like reference numbers and designations in the various drawings indicate like elements.

### SUMMARY OF THE INVENTION

One aspect of the present invention features a cover embedded with functions that adds functionality to an appliance. The cover includes a connection associated with the cover to connect to a peripheral port of the appliance, electronics and logic embedded into the cover that utilizes the connection to operate and provide one or more functions to complement operation of the appliance and a mechanism that removably couples the cover to the appliance.

### DETAILED DESCRIPTION

Aspects of the present invention are advantageous in at least one or more of the following ways. A cover for an appliance embedded with electronics both protects the appliance and increases functionality. The electronics and logic do not significantly increase the bulk of existing appliances as it is embedded inside a protective cover. Often, a cover is an item provided with the device upon purchase or quickly purchased thereafter to protect the device. Implementations of the present invention provide a cover for an appliance having added functionality without significantly increasing the size or bulk of the device.

Additionally, a cover designed in accordance with the present invention can replaced with other covers designed to provide a different function or functions to the appliance. Depending on the circumstances, a user may swap one cover and functionality in accordance with the present invention for another cover having a different functionality. The appliance is modified to fit a particular use by swapping out the cover and functionality rather than buying an additional appliance. Instead of carrying multiple appliances, the appropriate cover and functionality is combined with the underlying appliance to create a tailored and useful appliance.

Implementations of the present invention are also advantageous as they do not necessarily require a separate battery or storage. In one implementation, the cover designed in accordance with the present invention is connected to the appliance to facilitate sharing the battery or power supply, storage and other resources of the appliance. Sharing power and other resources on the appliance with the additional functions built into the cover helps reduce weight and bulk of the appliance device. Alternatively, implementations of the present invention can use a battery internal to the cover and therefore provide a longer operating time for both the cover and attached appliance.

Yet another advantage of the present invention is the proximity of the electronics in the cover relative to the appliance device. Separating the electronics in the cover from the appliance by a larger distance reduces potential interference from electromagnetic waves and radio communications. The separation between the cover and the appliance during operation obviates the need for extra shielding material thereby reducing costs and weight. It also makes developing and testing electronics to be installed in the cover more rapid as the combination of electronics in the cover and appliance is less likely to cause undesirable interference patterns. For example, electronics associated with a compass can be implemented in accordance with the present invention without additional calibration routines to account for the appliance electronics. Further, global position systems (GPS) and other wireless/satellite based electronics can better position a communications antenna at one of several angles to facilitate increased communications between the antenna and a target satellite, base station or other signal source communicating with the electronics in the cover.

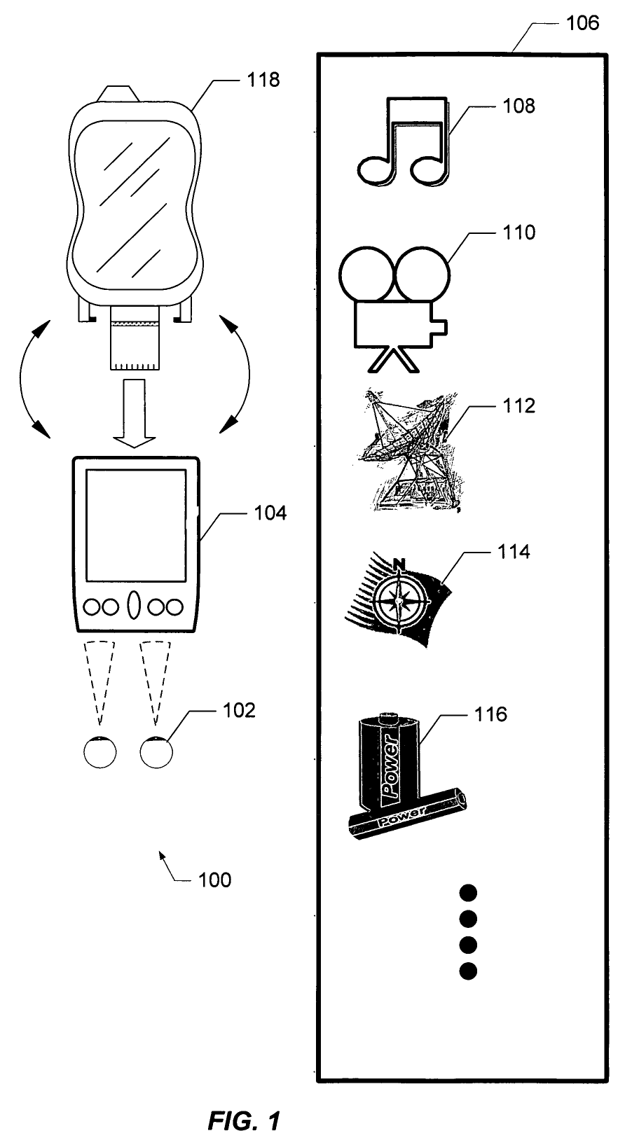

FIG. 1 is a schematic diagram of a system 100 having an appliance 104 and a smart cover 118 designed in accordance with implementations of the present invention. As illustrated, system 100 includes appliance 104 removably fitted with smart cover 118. In this example, smart cover 118 includes hinges for securing to appliance 104 and a connection that couples smart cover 118 to a peripheral port of appliance 104. Both appliance 104 and smart cover 118 can be seen and then operated upon by viewer 102 gazing at the interface area of each respective component.

Appliance 104 can be a personal digital assistant (PDA), a wireless voice communication device, or a pocket computer. For example, a wireless voice communication device includes digital cellular phones, push-to-talk phones, and any other device capable of facilitating voice communications. In the example illustration, appliance 104 has four buttons, a center toggle button, a combination display and touch-sensitive screen, a peripheral port for receiving flash-memory storage, and receiving area for the hinge on smart cover 118 (not illustrated). Alternate implementations of appliance 104 can include any combination and position of buttons and screens. These alternate implementations may use different types of screens, no-buttons, different types of buttons and many other types of interfaces.

In addition to being removable and swappable, smart cover 118 embeds electronics and logic in the cover to provide one or more additional functions 106. For example, these functions 106 include a music device 108 capable of recording and playback of music and/or voice, an image or video camera 110, wireless capabilities 112, navigational functions 114, auxiliary power 116, and many other functions. The wireless capabilities 112 include: Bluetooth, CDMA, Wi-Fi, GSM, TDMA, AMPS, Infra-red, Radio Frequency (RF) and other wireless technologies. Navigational functions 114 include global positioning systems (GPS) using satellites and other types of positioning systems that operate using terrestrial instead of satellite systems.

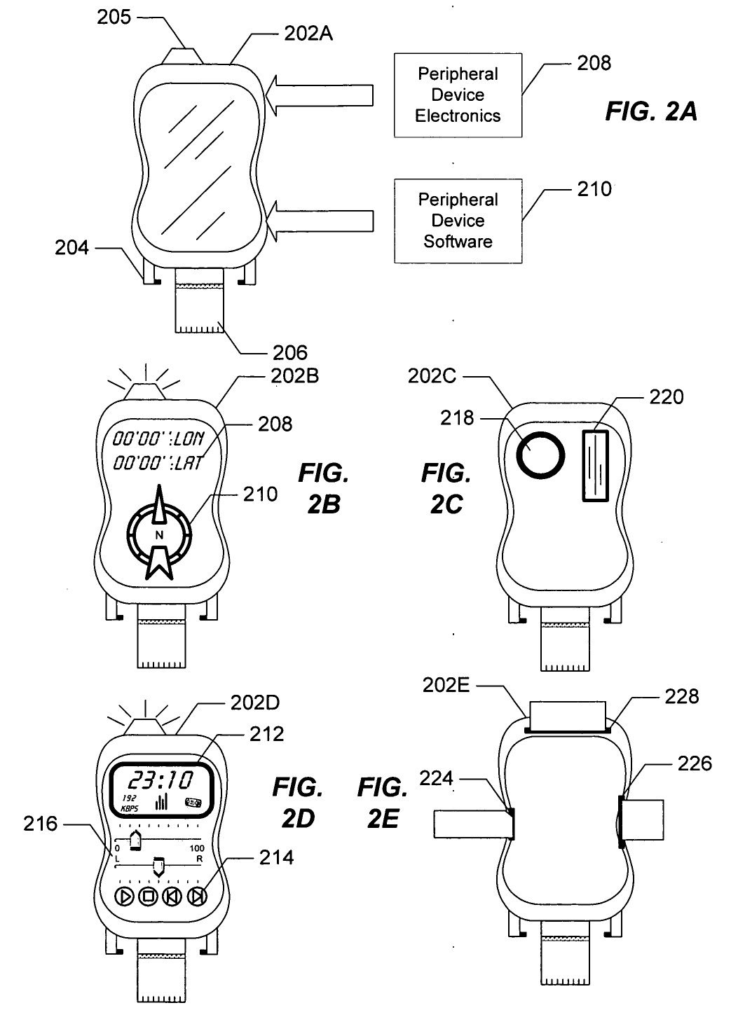

FIG. 2A-2E are schematic diagrams illustrating various smart cover designs implemented in accordance with the present invention. A smart cover is removably attached to the cover surface of an appliance using a slidable, hinged or other attachment mechanism providing a mechanical connection point to the appliance. In FIG. 2A, a smart cover 202A is one implementation that includes hinges 204, an antenna 205 for wireless communication, a connection 206, peripheral device electronics 208, and peripheral device software 210. In this illustrated example, hinges 204 extend out from the bottom of smart cover 202A providing a mechanical connection point with the appliance it covers. Hinges 204 provide a mechanism that removably couples smart cover 202A to the appliance in a position that provides protection to an operable surface of the appliance. For example, smart cover 202A covers the operable surface on top of the appliance protecting the surface of a screen and buttons on the appliance from damage or exposure. It is contemplated that alternate implementations of the present invention are not limited to using hinges 204 as the mechanical connection point as this is only one example of attaching smart cover 202A of the present invention to the surface of an appliance device.

In this illustrated example, connection 206 has the leads and shape compatible with a secure digital (SD) form factor and allows smart cover 202A to communicate data and potentially receive power through the peripheral port of the appliance also designed for use with the SD device form factor. Optionally, smart cover 202A includes an internal power supply or connects to a power supply through a separate connection (not illustrated) rather than through connection 206. Alternatively, connection 206 can be designed to be compatible with other flash disk formats including a memory stick (MS), a compact flash (CF), or smart media. Other types of connection 206 can also created using various versions of Universal Serial Bus (USB), serial port, parallel port, Firewire and BlueTooth technologies. Connection 206 can also be used for providing power and not data as well as for increasing the mechanical coupling between smart cover 202A and the appliance.

Peripheral device electronics 208 includes the electronics, logic, and circuitry required to make smart cover 202A provide the specified functions. Generally, smart cover 202A includes electronics not already included in the appliance and shares those features already part of the appliance. Accordingly, one implementation of the present invention electronics and logic embedded into the cover utilize connection 206 to operate and provide one or more functions to complement operation of the appliance. For example, peripheral device electronics 208 may include electronics and hardware for performing global positioning system (GPS) functions. The GPS information produced from the positioning system complements an address database in the appliance by locating the address on a map and providing a route to the address based on a current identified position. Alternatively, peripheral device electronics 208 includes a voice communication capability that complements a phone number database in the appliance by locating a phone number in the phone number database in response to voice commands and placing a call to the phone number. In both of these examples and others, costs associated with smart cover 202A are reduced by eliminating the screen as illustrated and instead using the touch-sensitive screen on the appliance to display information and receive user input information and data.

Like the hardware, peripheral device software 210 is specifically tailored for performing the one or more particular functions associated with smart cover 202A. For example, peripheral device software 210 provides user interface processing and displaying of information through a display and controls information through one or more soft buttons on the display. In addition, peripheral device software 210 may also provide processing support for various image, voice, audio, compression, encryption and other types of processing necessary to facilitate the particular function provided through smart cover 202A.

In FIG. 2B, a smart cover 202B includes the features of smart cover 202A described in FIG. 2A and is additionally configured to provide navigational position information 208 and an electronic compass 210 as displayed. Electronics in smart cover 202B provide navigational position information 208 using satellites or terrestrial base stations or fixed wireless loop devices in a building or campus. If street information is available on the appliance, smart cover 202B in FIG. 2B provides sufficient navigational position information to enable maps and turn-by-turn information to a particular destination. Alternatively, smart cover 202B does not include a display and instead uses the display and other resources already available on the appliance to display navigational position information 208. This alternate implementation of smart cover 202B is a more cost effective and lighter weight design as it shares more resources with the appliance.

FIG. 2C is smart cover 202C designed and configured to operate as an image or video camera device in accordance with one implementation of the present invention. In this example, smart cover 202C includes the features of smart cover 202A described in FIG. 2A along with a lens 218 to capture images and videos and a light 220 for illuminating the subject matter being taken by lens 218. Smart cover 202C uses the display on the attached appliance as a view display to see samples of images taken. Images taken with smart cover 202C can be stored locally on smart cover 202C or transferred to the appliance over connection 206 or wirelessly using BlueTooth or other wireless connection protocols.

FIG. 2D is smart cover 202D designed and configured to operate as a music recording and playback device in accordance with one implementation of the present invention. In this example, smart cover 202D includes the features of smart cover 202A described in FIG. 2A along with digital signal processing and amplification capabilities for playing, recording, and amplifying sound. The interface used in FIG. 2D includes a music display area 212 to keep track of statistics associated with the recording and playback of sound. Buttons 214 on smart cover 202D can be physical buttons or generated as “soft” buttons being displayed on a combination display and touch-sensitive screen. Controls 216 on smart cover 202D illustrated in this example operate the volume and balance of the sound produced by the music device. In an alternate implementation, smart cover 202D does not include a display and instead uses the display and other resources already available on the appliance to display music display area 212. Like smart cover 202B, this alternate implementation of smart cover 202D is a more cost effective and lighter weight design as it shares more resources with the appliance.

FIG. 2E is smart cover 202E designed and configured to operate as media adapter in accordance with one implementation of the present invention. In this example, smart cover 202E includes the features of smart cover 202A described in FIG. 2A along with physical connections that fit a variety of different flash memory and other media types. In this example, smart cover 202E includes a memory stick (MS) slot 224, a secure digital (SD) slot 226 and a compact flash/smart media slot 228. Functions provided by smart cover 202E allow legacy devices to readily connect to smart cover 202E for additional storage and other functions.

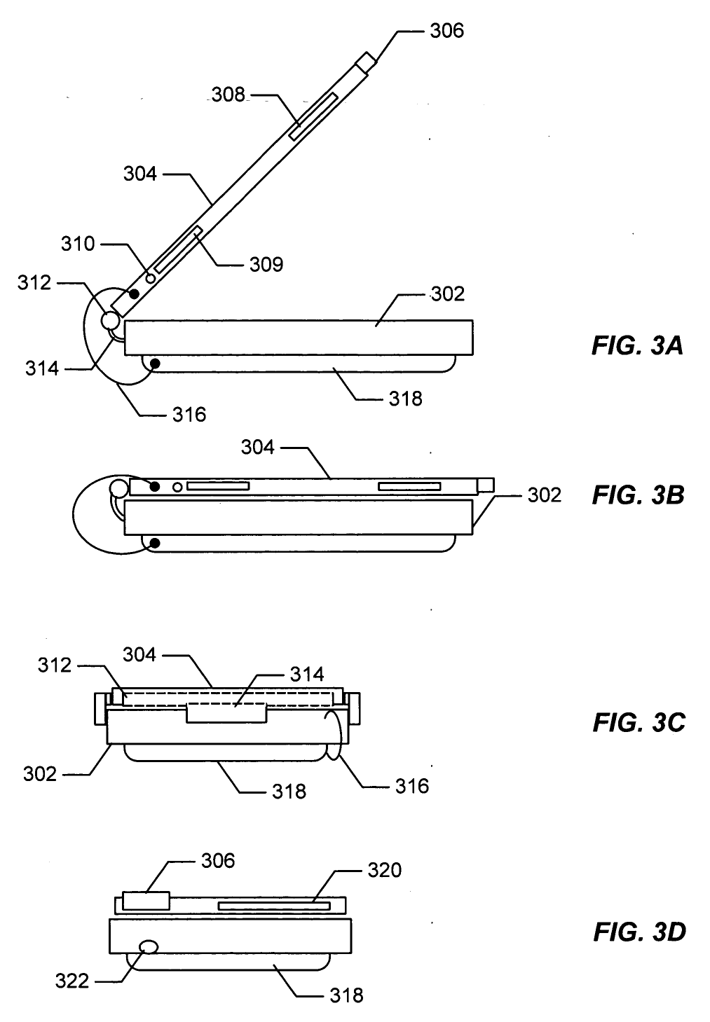

Referring to FIG. 3A through 3D are several different perspectives and views of a smart cover designed in accordance with implementations of the present invention. FIG. 3A illustrates a side perspective of smart cover 304 attached to an appliance 302 and in the open or partially open position. In this example, smart cover 304 includes an antenna 306, a media slot 308 for flash or other memory devices, a control slider 309 for adjusting volume or other similar function, a jack 310 for headphones or an earpiece, hinges 312 between smart cover 304 and appliance 302. A connection 314 and power cable 316 connect smart cover 304 to appliance 302 and optional external battery pack 318 coupled to appliance 302. FIG. 3B also illustrates a side perspective of smart cover 304 except smart cover 304 is in a closed position covering and protecting appliance 302.

The side perspective view along the shorter edge in FIG. 3C provides a different view of smart cover 304 in the closed position covering appliance 302. In this illustration, hinges 312 run along the width of smart cover 304 and appliance 302. FIG. 3D provides another perspective side view along the width of smart cover 304 except from the top width of the device. In the perspective illustrated in FIG. 3D, antenna 306 is seen over external battery pack 318 and adjacent to a media slot 320 for flash memory or other compatible devices. A pen slot 322 is available to hold a pen used for selecting elements on the user interface being displayed on the combination display and touch-sensitive screen.

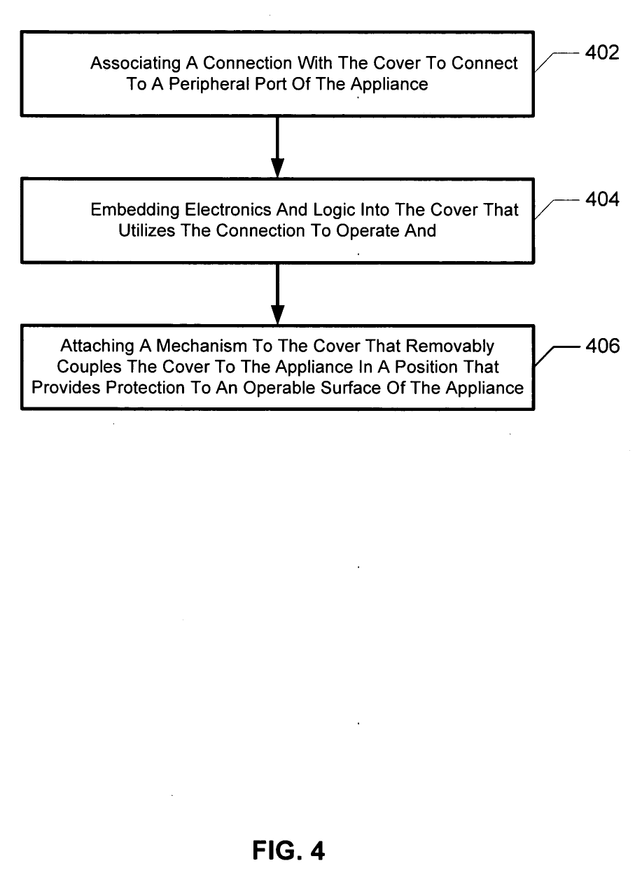

FIG. 4 is a flowchart diagram for manufacturing a smart cover designed in accordance with implementations of the present invention. Initially, the manufacturer associates a connection with the cover to connect to a peripheral port of the appliance (402). As previously described, the connection can assume the form-factor associated with one of many different flash memory devices. For example, the flash memory form factors could be selected from a set of flash memory form factors including: a memory stick (MS), a compact flash (CF), a secure digital (SD) card or a smart media card. Other types of connection 206 can also created using various versions of Universal Serial Bus (USB), serial port, parallel port, Firewire and BlueTooth technologies. The connection can be flexible connection to allow the smart cover to flex when opening or closing or can be a stiff connection equipped with mechanical-like hinges embedded in the cable.

The manufacturer then embeds electronics and logic into the cover that utilizes the connection to operate (404). In particular, the specific electronics and logic put inside the cover depends on the functions being provided by the smart cover. In one implementation, the manufacturer uses flexible IC circuitry to implement electronics or logic to create this aspect of the invention.

Next, the manufacturer attaches a mechanism to the cover that removably couples the cover to the appliance in a position that provides protection to an operable surface of the appliance (406). As previously described and illustrated in FIG. 2A, the cover can be removably attached to the cover surface of an appliance using a slidable, hinged or other attachment mechanism providing a mechanical connection point to the appliance. Hinges 204 provide a mechanism that removably couples smart cover 202A to the appliance in a position that provides protection to an operable surface of the appliance. For example, smart cover 202A covers the operable surface on top of the appliance protecting the surface of a screen and buttons on the appliance from damage or exposure. It is contemplated that alternate implementations of the present invention are not limited to using hinges 204 as the mechanical connection point as this is only one example of attaching smart cover 202A of the present invention to the surface of an appliance device. The hinge mechanism is typically a durable metal or composite material that is both lightweight and strong. For example, this material could be a composite material fortified with various metals including titanium, aluminum, light-weight steel, fiberglass or other suitable materials.

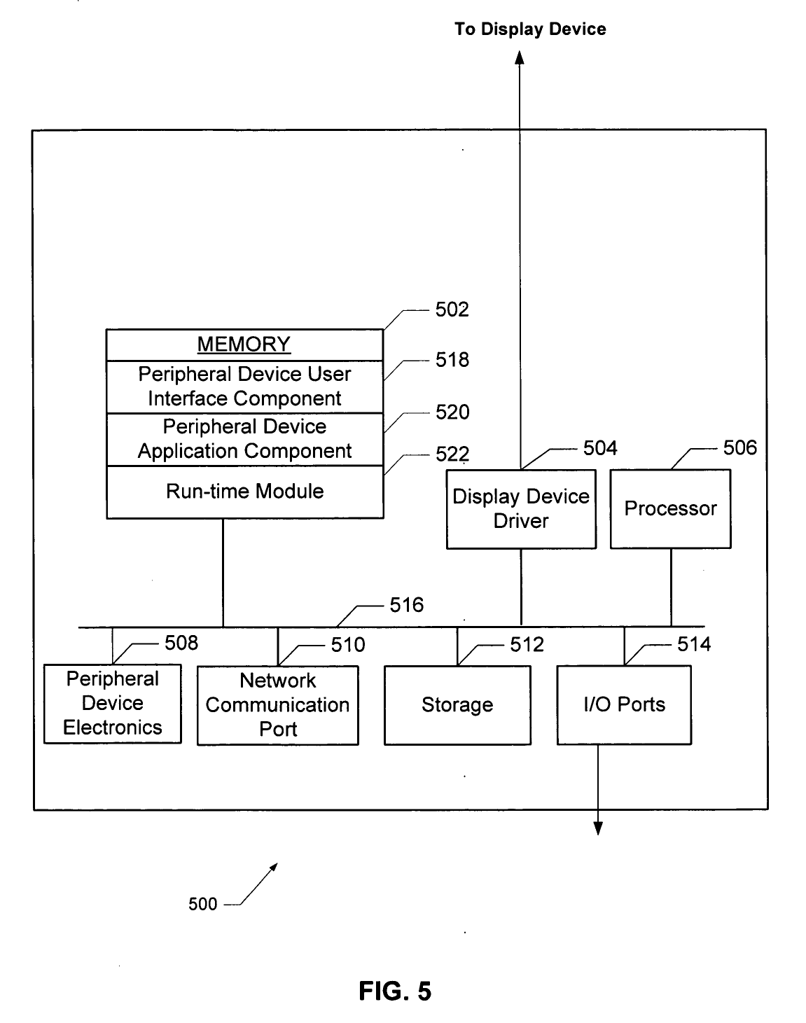

FIG. 5 is a schematic diagram of a smart cover 500, hereinafter system 500, and components used in accordance with one implementation of the present invention. System 500 includes a memory 502 to hold executing programs (typically random access memory (RAM) or read-only memory (ROM) such as a flash RAM), a display device driver 504 capable of interfacing and driving a display or monitor device, a processor 506, peripheral device electronics 508 providing hardware support for the smart cover functionality, a network communication port 510 for data communication, a storage 512, and input/output (I/O) ports 514 also with I/O controller operatively coupled together over an interconnect 516. As previously described, smart cover 500 generally uses the display and/or touch-sensitive screen of the appliance and consequently does not include an additional display to reduce costs, weight and power consumption requirements. For example, display device driver 504 is capable of interfacing with the display associated with the appliance and does not require a screen integrated with smart cover 500. Smart cover 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one implementation, memory 502 includes a peripheral device user interface component 518, peripheral device application component 520, and run-time module 522 that manages the resources associated with smart cover 500. In operation, peripheral device user interface component 518 presents a user interface on a combination display and touch-sensitive screen. A user operates certain aspects of smart cover 500 through this user interface. For example, peripheral device user interface component 518 presents the buttons to control the operation of a music playback device for MP3 music. The commands and requests are processed and fulfilled by peripheral device application component 520. Each different smart cover 500 operates differently and provides different levels of information depending on how both peripheral device user interface component 518 and peripheral device application component 520 are implemented.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

1. A cover for an appliance, comprising:
a connection associated with the cover to connect to a peripheral port of the appliance;
electronics and logic embedded into the cover that utilizes the connection to operate and provide one or more functions to complement operation of the appliance;
a mechanism that removably couples the cover to the appliance.

2. The apparatus of claim 1 wherein the cover can be positioned to provide protection to an operable surface of the appliance.

3. The apparatus of claim 1 wherein the appliance is selected from a set of appliances including: a personal digital assistant (PDA), a wireless voice communication device, and pocket computer.

4. The apparatus of claim 1 wherein the mechanism that removably couples the cover is selected from a set including: a hinge mechanism and a slider cover mechanism.

5. The apparatus of claim 1 wherein the connection associated with the cover is selected from a set of connections including: a flash storage device, a power cable, various versions of Universal Serial Bus (USB), serial port, parallel port, Firewire, BlueTooth technologies and a mechanical connection.

6. The apparatus of claim 5 wherein the flash storage device is selected from a set of flash storage devices including: a memory stick (MS), a compact flash (CF), a secure digital (SD), and a smart media.

7. The apparatus of claim 1 wherein the one or more functions provided include: a music device, a image camera, a video camera, wireless capabilities, a positioning system, a media adapter, and a power supply.

8. The apparatus of claim 7 wherein the wireless capabilities includes one or more wireless connections selected from a set of wireless connections including: BlueTooth, CDMA, Wi-Fi, GSM, TDMA, AMPS, Infra-red, and radio-frequency (RF).

9. The apparatus of claim 1 wherein one or more functions provided by the electronics and logic embedded into the cover complement one or more operations on the appliance.

10. The apparatus of claim 9 wherein the electronics and logic includes a positioning system that complements an address database in the appliance by locating the address on a map and providing a route to the address on the map based on a current identified position.

11. The apparatus of claims 9 wherein the electronics and logic complements includes a voice communication capability that complements a phone number database in the appliance by locating a phone number in the phone number database and placing a call to the phone number.

12. The apparatus of claim 1 wherein the operable surface of the appliance includes a combination display and touch-sensitive screen.

13. The apparatus of claim 1 wherein the operable surface of the appliance includes a display screen and a sequence of buttons for alpha-numeric data entry.

14. A cover for an appliance, comprising:
means for connecting the cover to a peripheral port of the appliance;
electronics and logic means embedded into the cover that utilizes the means for connecting to operate and provide one or more functions to complement operation of the appliance; and
means for removably coupling the cover to the appliance.

15. The apparatus of claim 14 wherein the cover can be positioned to protect an operable surface of the appliance.

16. A method of manufacturing a cover for an appliance, comprising:
associating a connection with the cover to be connected to a peripheral port of the appliance;
embedding electronics and logic into the cover capable of utilizing the connection to operate and capable of providing one or more functions to complement operation of the appliance; and
attaching a mechanism to the cover that can be used to removably couple the cover to the appliance.

17. The method of claim 16 wherein the cover can be positioned to protect an operable surface of the appliance.

18. The method of claim 16 wherein the appliance is selected from a set of appliances including: a personal digital assistant (PDA), a wireless voice communication device, and pocket computer.

19. The method of claim 16 wherein the mechanism that removably couples the cover is selected from a set including: a hinge mechanism and a slider cover mechanism.

20. The method of claim 16 wherein the connection associated with the cover is selected from a set of connections including: a flash storage device, a power cable, various versions of Universal Serial Bus (USB), serial port, parallel port, Firewire, BlueTooth technologies and a mechanical connection.

21. The method of claim 20 wherein the flash storage device is selected from a set of flash storage devices including: a memory stick (MS), a compact flash (CF), a secure digital (SD), and a smart media.

22. The apparatus of claim 16 wherein the one or more functions provided include: a music device, a image camera, a video camera, wireless capabilities, a positioning system, a media adapter, and a power supply.

23. The method of claim 22 wherein the wireless capabilities includes one or more wireless connections selected from a set of wireless connections including: BlueTooth, CDMA, Wi-Fi, GSM, TDMA, AMPS, Infra-red, and radio-frequency (RF).

24. The method of claim 16 wherein one or more functions provided by the electronics and logic embedded into the cover complement one or more operations on the appliance.

25. The method of claim 24 wherein the electronics and logic includes a positioning system that complements an address database in the appliance by locating the address on a map and providing a route to the address on the map based on a current identified position.

26. The method of claims 24 wherein the electronics and logic complements includes a voice communication capability that complements a phone number database in the appliance by locating a phone number in the phone number database and placing a call to the phone number.

27. The method of claim 17 wherein the operable surface of the appliance includes a combination display and touch-sensitive screen.

28. The method of claim 17 wherein the operable surface of the appliance includes a display screen and a sequence of buttons for alpha-numeric data entry.

29. The method of claim 16 wherein the connection to be made between the cover and the appliance uses a flexible material.

30. The method of claim 16 wherein the connection to be made between the cover and the appliance uses a stiff material equipped with embedded mechanical-like hinges.

31. The method of claim 15 wherein the electronics and logic embedded inside the cover are implemented using flexible IC circuitry.

32. The method of claim 16 wherein the mechanism is a material that is both lightweight and strong.

33. The method of claim 32 wherein the material is a composite material fortified with one or more materials selected from a set of materials including: titanium, aluminum, light-weight steel, and fiberglass.
